(19) United States
(12) Patent Application Publication
(10) Pub. No.: US 2004/0179792 A1
(43) Pub. Date: Sep. 16, 2004

(54) Optical fiber transfer apparatus

(76) Inventor: Yin-Hsiang Thy, Yonghe City (TW)

Correspondence Address: TROXELL LAW OFFICE PLLC, 5205 Leesburg Pike,, Suite 1404, Falls Church, VA, 22041, US

(21) Appl. No.: 10/793,816

(22) Filed: Mar. 8, 2004

(30) Foreign Application Priority Data
Mar. 14, 2003 (TW) 092203914

(51) Int. Cl. G02B 6/42

(52) U.S. Cl. 385/89

(57) ABSTRACT

Present invention is an optical fiber transfer apparatus which comprises two optical transfer facilities, two transfer connectors and a fiber cable, wherein each optical transfer facility comprises an optical transmitter and an optical receiver and is tied in with a transfer connectors and a fiber cable is between the two transfer connectors. The transfer connector comprises a coupler and an isolator, wherein the optical signal from the optical transmitter enters into terminal T of the isolator and is transferred to terminal C of the coupler that a one-way transmission channel is formed at the isolator. And the optical signal from terminal C of the coupler will be hindered by the isolator and be transferred to the optical receiver through terminal R of the coupler. Accordingly, by using only one fiber in the fiber cable, cost reduction, easy installation and a two-way transmission for optical signal can be achieved.

### FIELD OF INVENTION

Present invention relates to an optical fiber transfer apparatus; more particularly, relates to an optical fiber transfer apparatus comprising two optical transfer facilities that each facility comprises an optical transmitter and an optical receiver and is tied in with a corresponding transfer connectors and a fiber cable is between the two transfer connectors, wherein each transfer connector comprises a coupler and an isolator. Accordingly, by using only one fiber in the fiber cable, cost reduction, easy installation and a two-way transmission for optical signal can be achieved that the present invention can be used at a control room, road facilities, etc. and in kinds of devices for communication and networking.

### DESCRIPTION OF RELATED ART

As is known, a related art of an optical fiber transfer apparatus comprises two optical transfer facilities 1,3 and a fiber cable 2 (please refer to FIG. 1), wherein each optical transfer facility 1,3 comprises an optical transmitter 11,31 and an optical receiver 12,32. The optical transmitter 11 transmits an optical signal to a switching line 13; and through the bonded wiring board 15, the optical signal is transmitted to a fiber 21 in the fiber cable 2; and through the fiber 21, the optical signal is transmitted to another wiring board 35; and finally through the bonded switching line 34, the optical signal is transmitted to the other corresponding optical receiver 32. The other corresponding optical transmitter 31 will accordingly transmit an optical signal to a connected switching line 33; and through the bonded wiring board 35, the optical signal is transmitted to another fiber 21 in the fiber cable 2; and through the fiber 22, the optical signal is transmitted to the other wiring board 15; and finally through another bonded switching line 14, the optical signal is transmitted to the corresponding optical receiver 12. Accordingly, by two optical transfer facilities 1,3 and two fibers 21,22 in a fiber cable 2, a two-way transmission of optical signal is achieved. Although twoway transmission is achieved, yet on using, two fibers are required so that many expansive fibers is consumed as well as much more time spent on installation. So, it does not meet the need of the user on actual usage.

### BRIEF SUMMARY OF THE INVENTION

The main purpose of the present invention is to provide an optical fiber transfer apparatus comprising two optical transfer facilities that each facility comprises an optical transmitter and an optical receiver and is tied in with the corresponding transfer connectors and the fiber cable is between the two transfer connectors, wherein the transfer connector comprises a coupler and an isolator. Accordingly, by using only one fiber in the fiber cable, cost reduction and a two-way transmission for optical signal can be achieved for better practical usage.

Another purpose of the present invention is to provide an optical fiber transfer apparatus, wherein the transfer connector is in an integrated form for easy usage and for installation without changing the original parts that the old as well as the new parts can be coordinated on disposition to improve practical usage and convenience.

The third purpose of the present invention is to provide an optical fiber transfer apparatus, wherein the transfer connector 5,10 can be directly put inside of the optical transfer facility 4,8 to lessen the number of the sockets to only one for outside connection; and the optical transmitter and the optical receiver no more need to be put outside of the optical transfer facility 4,8 so that the wiring error can be avoided and the manufacture cost can be diminished and its security and convenience is improved.

To achieve the above purposes, the present invention is an optical fiber transfer apparatus which comprises two optical transfer facilities, two transfer connectors and a fiber cable, wherein each optical transfer facility comprises an optical transmitter and an optical receiver and is tied in with a transfer connector and the fiber cable is between the two transfer connectors. The transfer connector comprises a coupler and an isolator, wherein the optical signal from the optical transmitter enters into terminal T of the isolator and is transmitted to terminal C of the coupler that a one-way transmission channel is formed at the isolator and the optical signal from the optical transmitter is hindered by the isolator and so the optical signal is transmitted to the optical receiver through terminal R of the coupler. Accordingly, by using only one fiber in the fiber cable, cost reduction, easy installation and a two-way transmission for optical signal can be achieved.

### BRIEF DESCRIPTION OF THE DRAWINGS

The present invention will be better understood from the following detailed description of preferred embodiments of the invention, taken in conjunction with the accompanying drawings, in which

FIG. 1 is a perspective view of the related art showing status of use;

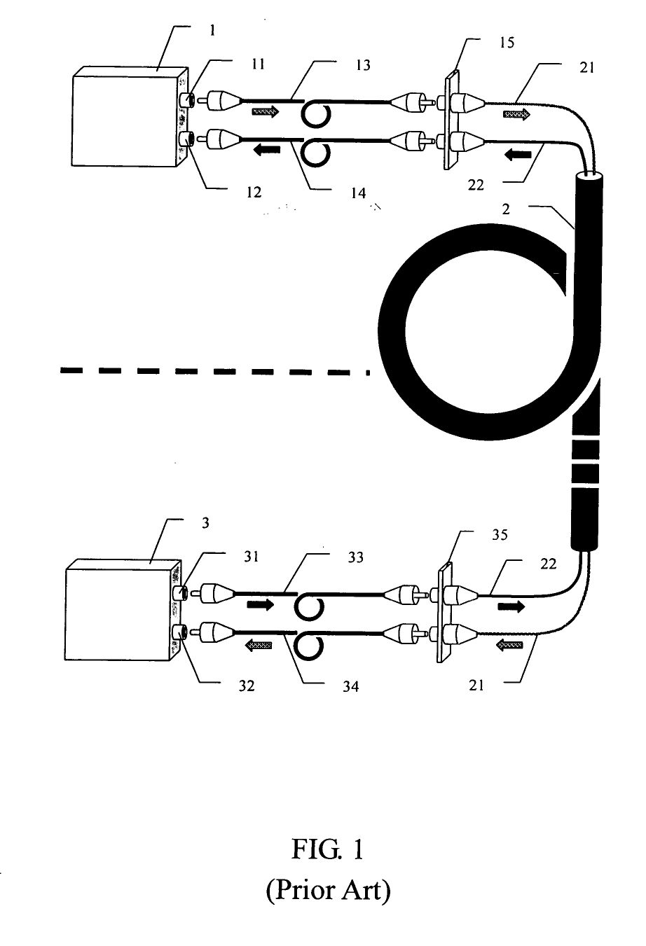

FIG. 2 is an exploded view of the structure of the first embodiment according to the present invention;

FIG. 3 is a perspective view of the transfer connector of the first embodiment according to the present invention;

FIG. 4 is a perspective view of the second embodiment according to the present invention;

FIG. 5 is a perspective view of the third embodiment according to the present invention;

FIG. 6 is a perspective view of the fourth embodiment according to the present invention;

FIG. 7 is a perspective view of the fifth embodiment according to the present invention;

FIG. 8 is a perspective view of the sixth embodiment according to the present invention;

FIG. 9 is a perspective view of the seventh embodiment according to the present invention; and

FIG. 10 is a perspective view of the eighth embodiment according to the present invention.

### DESCRIPTION OF THE PERFERRED EMBODIMENTS

The following descriptions of the preferred embodiments are provided to understand the features and the structures of the present invention.

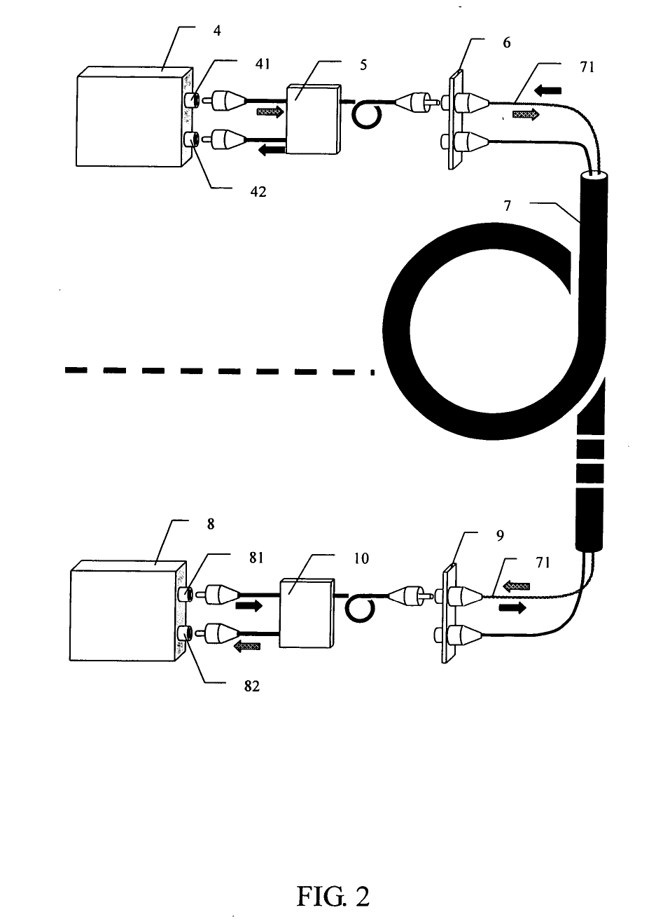

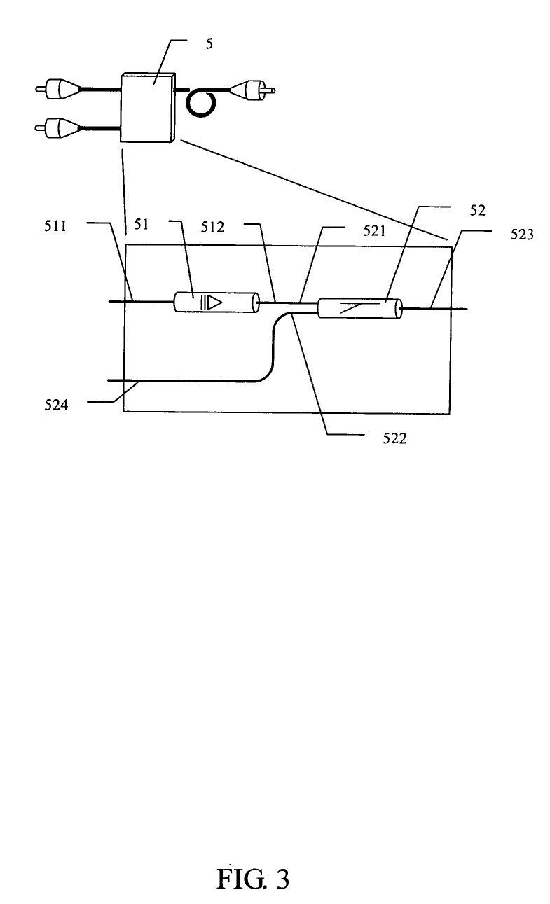

Please refer to FIG. 2 and FIG. 3, the present invention comprises two optical transfer facility 4,8, two transfer connector 5,10 and a fiber cable 7, wherein each optical transfer facility 4,8 (ex. communication or network facility) comprises an optical transmitter 41,81 and an optical receiver 42,82 and is tied in with the corresponding transfer connectors 5,10 and the fiber cable 7 is between the two transfer connectors 5,10 for transmitting the signal.

The transfer connector 5 comprises a coupler 51 and an isolator 52. The optical signal from the optical transmitter 41 enters from terminal T 511 of the isolator is directed to terminal T1 512 of the isolator and then enters into terminal C1 521 of the coupler and is transferred to terminal C 523 of the coupler. And, the optical signal from terminal C 523 of the coupler is directed to terminal C1 521 and terminal C2 522 of the coupler. After the optical signal has passed through terminal T1 512 of the isolator, the optical signal is hindered by the isolator 51 from turning to terminal T 511 of the isolator and so a one-way transferring channel is formed at the isolator 51. So, only terminal C2 522 of the coupler will transfer the optical signal to the terminal R 524 (i.e. the receiver) and the optical signal is transferred out by the terminal R 524 connected to the optical receiver 42.

And, terminal C 523 of the coupler is tied in with a wiring board 6 and another terminal of the wiring board 6 is connected with a fiber 71 in the fiber cable 7; and the other end of the fiber 71 is connected with another wiring board 9 and then another transfer connector 10 and then another optical transfer facility 8, which is constructed in the same way as previously stated.

And, terminal T of the isolator and terminal C and terminal R of the coupler can each be a fiber or a switching line with a joint.

According to the above structure, an optical fiber transfer apparatus is obtained. Please refer to FIG. 2 and FIG. 3, the main feature of the present invention is as what follows. An optical transmitter 41,81 and an optical receiver 42,82 are in each of the two optical transfer facilities 4,8 that are tied in with the two transfer connectors 5,10; and a fiber cable 7 is between the two optical transfer connectors 5,10; and, because the transfer connector 5 (the same to the other transfer connector 10) comprises a coupler 52 and an isolator 51, only a fiber 71 in the fiber cable 7 is required to achieve a two-way transmission for optical signal where originally two fibers is required in the past; and the number of the expansive fibers required is greatly reduced which lowers the whole cost. Because the transfer connector 5,10 is made into a mono body for easy usage, a twoway transmission for optical signal can be obtained without changing the original parts. And, because the transfer connector 5,10 can be directly put in the optical transfer facility 4,8 to reduce the number of the sockets to only one for outside connection, the optical transmitter and the optical receiver no more need to be put outside of the optical transfer facility 4,8 and the wiring error can be avoided and the manufacture cost can be diminished. So, by using only one fiber in the fiber cable, the present invention can achieve cost reduction, easy installation and a two-way transmission for optical signal to improve its practical and convenient usage that an optical fiber transfer apparatus is obtained.

Please refer to FIG. 2 and FIG. 3, after the installation of the above components, the optical signals from the optical transmitter 41 can enter from the terminal T 511 of the isolator and be passed to the terminal T1 512 of the isolator and be transferred to the terminal C 523 of the coupler. The terminal C 523 of the coupler is connected with the wiring board 6 and a terminal of the wiring board 6 is connected with a fiber 71 in the fiber cable 7 and the other end of the fiber 71 is connected with another wiring board 9 and sequentially is connected with the corresponding transfer connector 10. The entered optical signals now will be hindered by the isolator in the transfer connector 10 (not shown in the figures) so that the optical signals are transmitted to an optical receiver 82. In the like, an optical signal from the other optical transmitter 81 can enter from the other transfer connector 10 and be transferred to the other optical receiver 42. Accordingly, a two-way transmission of optical signal can be achieved by only one fiber in the fiber cable.

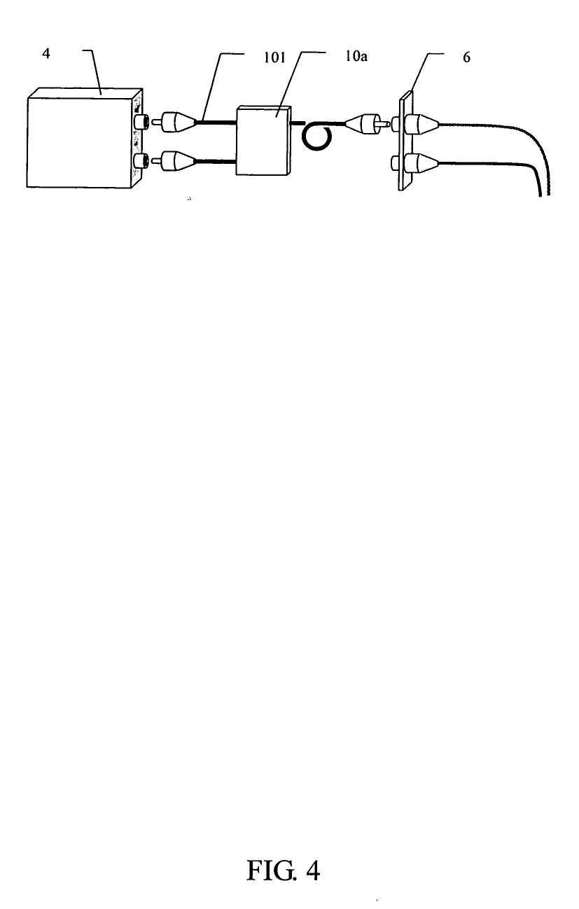

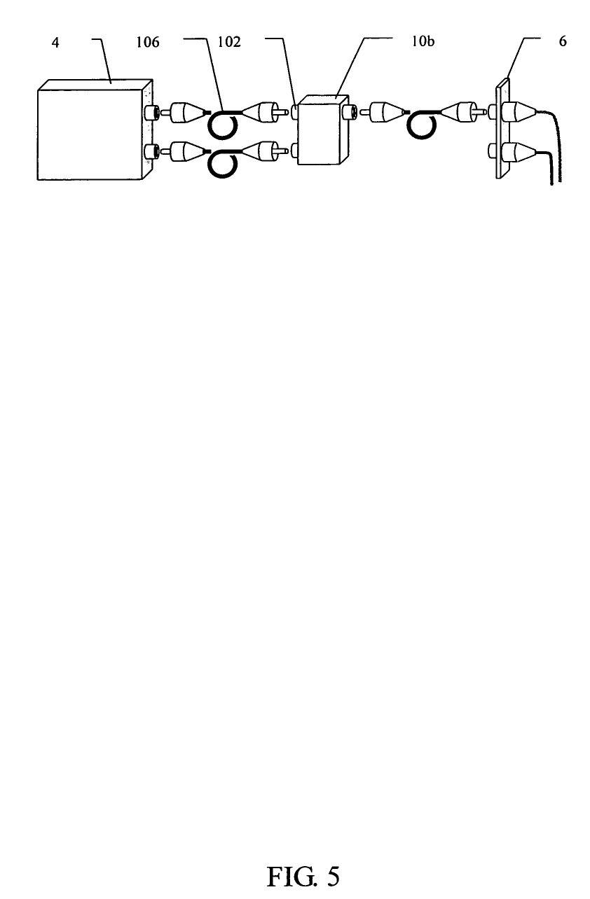

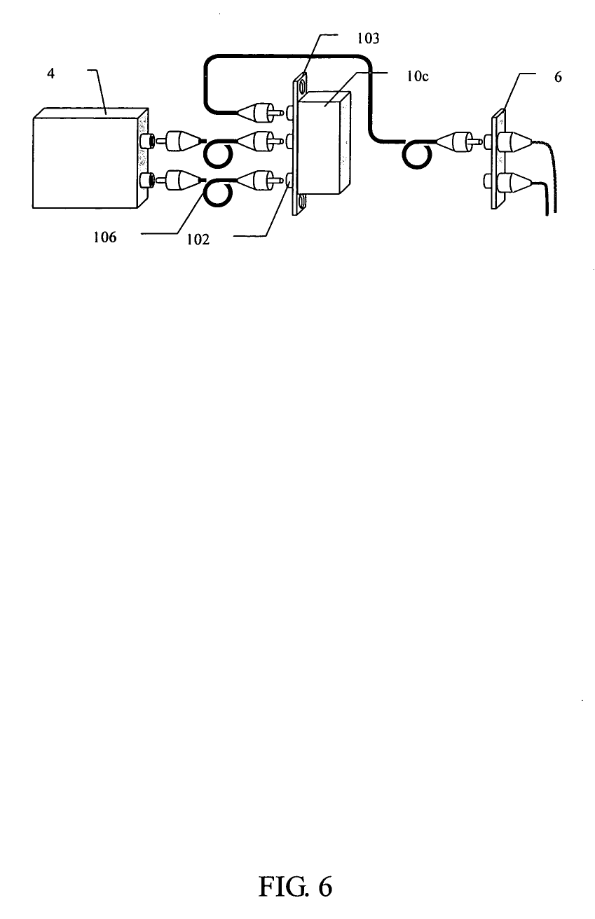

On using, the transfer connector 10a can be a mono body, as shown in FIG. 4, which comprises a switching line 101 (or a switching line and a joint) to connect with the optical transfer facility 4 and wiring board 6 for easy usage and for easy assembling without changing the original parts that a two-way transmission for optical signal can be achieved. As shown in FIG. 5, the mono body of transfer connector 10b can also comprises a socket 102 to connect with the optical transfer facility 4 and the wiring board 6 through switching lines 106. Or, as shown in FIG. 6, the mono body of transfer connector 10c can comprise a socket 102 (or a switching line) and a panel 103 for installing on a wiring shelf and for easy usage and for easy assembling without changing the original parts that a two-way transmission for optical signal can be achieved.

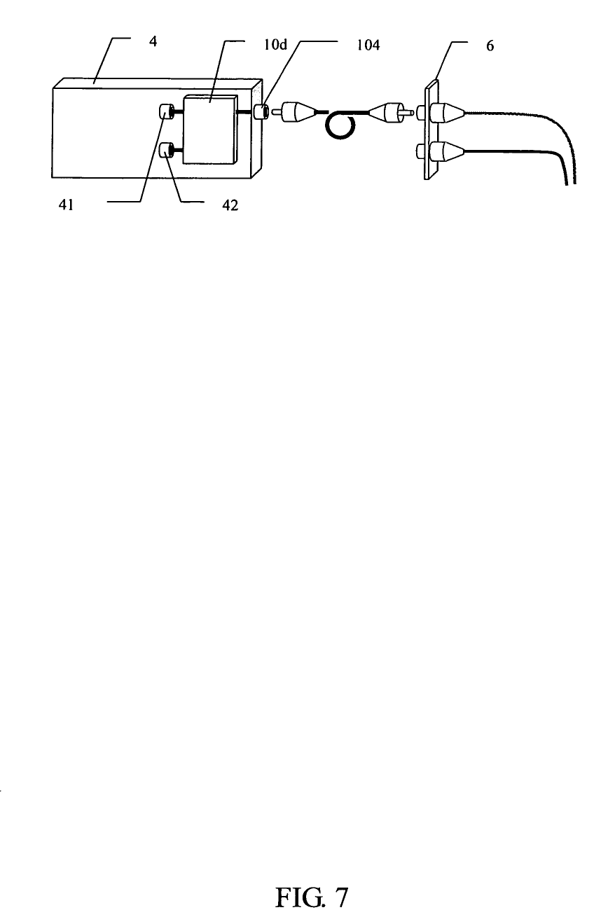

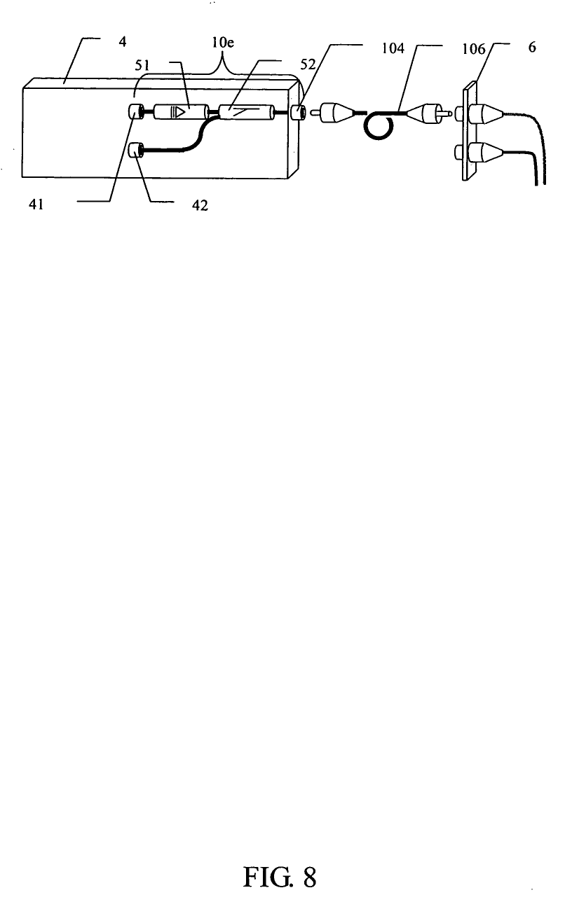

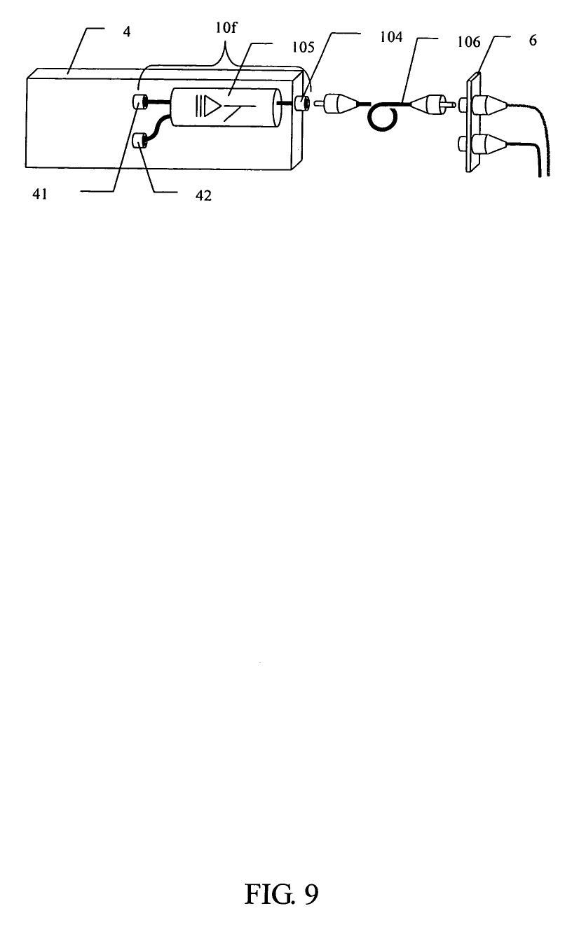

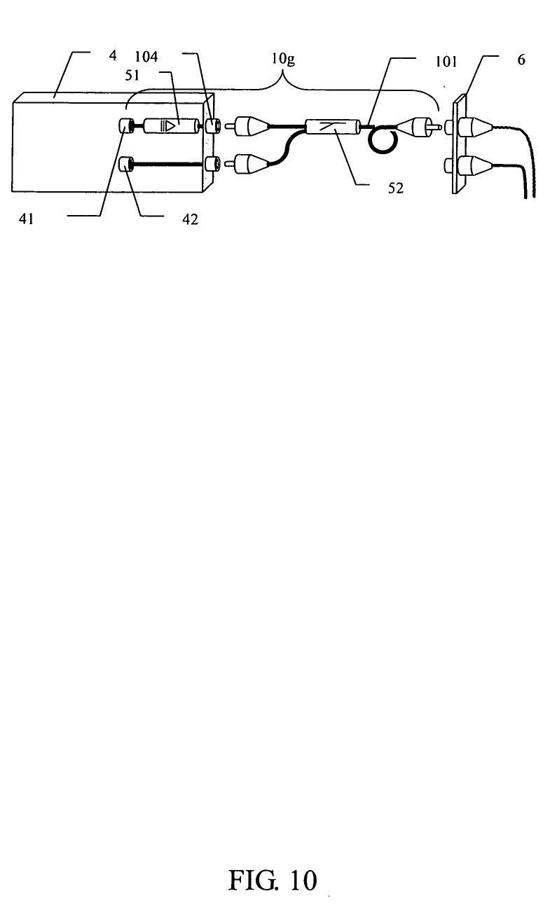

Please refer to FIG. 7, on using, the transfer connector 10d can be made into a mono body to be directly installed in the optical transfer facility 4. Or, as shown in FIG. 8, the transfer connector 10e can comprise a coupler 52 and an isolator 51 and is installed in the optical transfer facility 4, or can comprise a mono body 105 (i.e. transfer connector 10f) made by a coupler and an isolator in an integrated form (please refer to FIG. 9) to reduce the number of the outside sockets to only one owing to that the optical transmitter 41 and the optical receiver 42 no more need to be put outside of the optical transfer facility 4 so that wiring error can avoided and the manufacture cost can be lowered. Or, by putting the isolator 51 inside of the optical transfer facility 4 (please refer to FIG. 10) and the coupler 52 outside, a transfer connector 10g is obtained where each terminal of the coupler 52 is a switching line 101 with a joint.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. An optical fiber transfer apparatus, comprising two optical transfer facilities, two transfer connectors and a fiber cable; each said optical transfer facility comprising an optical transmitter and an optical receiver and being tied in with one said transfer connector; said fiber cable connecting said two transfer connectors,
wherein each said transfer connector comprises a coupler and an isolator,
wherein optical signal from said optical transmitter is to enter into terminal T of said isolator and be transferred to terminal C of said coupler, which terminal is connected with a fiber in said fiber cable, and the optical signal from terminal C of said coupler is to be hindered by said isolator from turning to terminal T of said isolator and so a one-way transmission channel is formed at said isolator and only terminal R of said transfer connector connected to said coupler is to receive optical signal from terminal C of said coupler.

2. The optical fiber transfer apparatus according to claim 1,
wherein optical signal from terminal T of said isolator is to be directed to terminal T1 of said isolator and then is to enter into terminal C1 of said coupler and to be transmitted to terminal C of said coupler,
wherein said optical signal from terminal C of said coupler is to be directed to terminal C1 and terminal C2 of said coupler and, after said optical signal has passed through terminal T1 of said isolator, said optical signal is to be hindered by said isolator from turning to terminal T of said isolator and so a one-way transmission channel is formed at said isolator.

3. The optical fiber transfer apparatus according to claim 1,
wherein terminal T of said isolator and terminal C and terminal R of said coupler are each a fiber,

4. The optical fiber transfer apparatus according to claim 1,
wherein terminal T of said isolator and terminal C and terminal R of said coupler are each a switching line with a joint,

5. The optical fiber transfer apparatus according to claim 1,
wherein a wiring board is between terminal C of said coupler and a fiber in said fiber cable for connecting with each other.

6. The optical fiber transfer apparatus according to claim 1,
wherein said transfer connector is in said optical transfer facility to reduce the number of outside sockets to one.

7. The optical fiber transfer apparatus according to claim 1,
wherein said transfer connector is a mono body.

8. The optical fiber transfer apparatus according to claim 1,
wherein said transfer connector is a mono body comprising said coupler and said isolator in an integrated form.

9. The optical fiber transfer apparatus according to claim 1,
wherein said transfer connector comprises said isolator located in said optical transfer facility and said coupler located at the outside, and
wherein each terminals of said coupler is a switching line with a joint.
